(19) United States
(12) Patent Application Publication
(10) Pub. No.: US 2013/0112807 A1
(43) Pub. Date: May 9, 2013

(54) METHOD FOR REDUCING AIRCRAFT MAINTENANCE COSTS AND TIME OUT OF SERVICE

(71) Applicant: Borealis Technical Limited, London (GB)

(72) Inventors: Isaiah W. Cox, Baltimore, MD (US); Rodney T. Cox, North Plains, OR (US)

(73) Assignee: BOREALIS TECHNICAL LIMITED, London (GB)

(21) Appl. No.: 13/671,561

(22) Filed: Nov. 8, 2012

Related U.S. Application Data
(60) Provisional application No. 61/557,390, filed on Nov. 8, 2011.

(51) Int. Cl. B64C 25/36

(52) U.S. Cl. CPC B64C 25/36
USPC 244/50

(57) ABSTRACT

A method for reducing both an aircraft's scheduled and unscheduled maintenance costs and an aircraft's time out of service for maintenance, repair, and overhaul is provided. The present method is implemented by providing onboard drive means on an aircraft capable of translating torque through aircraft wheels and controllable to move the aircraft independently on the ground without reliance on the aircraft's engines or external tow vehicles. Substantially eliminating the use of an aircraft's main engines and tow vehicles to move the aircraft on the ground between landing and takeoff significantly reduces and may substantially eliminate aircraft maintenance requirements and aircraft time out of service and produces quantifiable substantial cost savings.

### PRIORITY CLAIM

This application claims priority from U.S. Provisional Application No. 61/557,390, filed Nov. 8, 2011, the disclosure of which is fully incorporated herein.

### TECHNICAL FIELD

The present invention relates generally to the time an aircraft is out of service for maintenance, repair, and overhaul and costs for aircraft maintenance and, specifically, to a method for reducing both aircraft time out of service and aircraft maintenance costs.

### BACKGROUND OF THE INVENTION

The operation of airlines and airports today focuses on achieving maximum efficiency to keep operating costs as low as possible while continuing to provide travelers with a safe and economical mode of travel. Airline operations begin with a set of scheduled flights, from which costs and revenues are generated. The development of the flight schedule involves forecasting demand for flights between different airports, including considerations of competition, market share, and aircraft availability. Once a flight schedule has been adopted, a variety of problems related to the implementation and operation of the schedule can arise. For example, aircraft and crew must be assigned to specific flights, ticket prices must be resolved, and aircraft must be maintained in accordance with Federal Aviation Administration (FAA) maintenance guidelines in the United States and/or other jurisdictions' maintenance guidelines, depending on the extent and location of an airline's flight operations.

Consideration of maintenance constraints has long been recognized to be a cornerstone in aircraft scheduling. The development of an aircraft maintenance schedule is a complicated task involving the synthesis of many factors. Demand for service, aircraft utilization and operational cost of aircraft are the principal drivers. The goal is to achieve a balanced pattern of flights that results in a timetable consistent with the FAA and other countries' regulations and airline policies. The operating environment of major airlines in the United States changed significantly following airline deregulation in 1978, which led to deregulation to a greater or lesser extent in different countries worldwide. Increasingly fierce competition has led airlines to reduce prices, which has resulted in more passengers flying than in the past, and airlines have added flights to keep up with the demand. By some estimates, more than 80% of passengers are now traveling on tickets priced at less than full base fare. This downward pressure on revenues, accompanied by increasing fuel prices, has led many airlines to focus their attention on controlling operating costs, especially maintenance costs. An airline's financial health can be determined by how effectively such costs can be controlled.

It has been estimated that a significant portion, in the range of about 10 to 20%, of aircraft-related operating costs is represented by aircraft maintenance costs. Although these costs vary depending, for example, on aircraft type, average flight segment length, and aircraft age, they can represent substantial amounts. The maintenance budgets for large carriers can exceed $1 billion, which may not include the cost of chartering or leasing other aircraft while the carrier's aircraft are out of service for maintenance.

The United States FAA and international aviation authorities, including the European Aviation Safety Agency (EASA), and many other agencies worldwide, require maintenance checks for commercial aircraft at intervals defined by time, aircraft usage, and/or flight cycles to ensure that aircraft are airworthy and safe. For example, the FAA requires four levels of maintenance checks, ranging from the “A” check done every 500 to 800 flight hours, usually at an airport gate, to the heavy maintenance “D” check, done every 5 to 6 years, which can require an aircraft to be out of service for 3 weeks to 2 months. The FAA-required intermediate maintenance checks also necessitate the removal of an aircraft from service for periods of time ranging from days to weeks. When an aircraft is out of service for time periods of these lengths, an airline must increase utilization of aircraft in its fleet or use a replacement aircraft to keep its flight schedule in operation and avoid loss of revenue.

Although potentially costly, regular, planned maintenance is predictable and can be included in airline budget projections and schedules. Unscheduled and unanticipated aircraft maintenance and/or repair, whatever the cause, is more difficult to plan for and potentially even more costly. In today's competitive environment, airlines are looking at available options for reducing operating costs generally and maintenance costs in particular. Improvements in aircraft design that reduce maintenance have been proposed. While such improvements are likely to reduce future maintenance costs, they require the production and construction of new aircraft, a lengthy and multiple years-long process. Improvements in the scheduling and efficiency of aircraft maintenance that are intended to reduce costs have been proposed, by Wingenter in U.S. Patent Application Publication No. US2010/0262442, for example. While systems such as these improve the ability to project an aircraft's maintenance costs and enable more effective maintenance and aircraft time of out service planning, they do not effectively reduce an aircraft's need for maintenance or its time out of service as a result of that maintenance.

The prior art does not provide a method for reducing aircraft scheduled and unscheduled maintenance costs that can be implemented effectively within a relatively short time period. A need exists, therefore, for an efficiently implemented method that reduces both an aircraft's scheduled and unscheduled maintenance costs and an aircraft's time out of service for maintenance.

### SUMMARY OF THE INVENTION

It is a primary object of the present invention, therefore, to overcome the deficiencies of the prior art and to provide a method for reducing both an aircraft's maintenance costs and an aircraft's time out of service for scheduled and unscheduled maintenance.

It is another object of the present invention to provide a method for reducing aircraft maintenance costs that can be effectively implemented within a relatively short time.

It is an additional object of the present invention to provide a method for reducing aircraft maintenance costs and time out of service that can be used to achieve these reductions in a wide variety of existing aircraft.

It is a further object of the present invention to provide a method for reducing aircraft time out of service as a result of repair or maintenance related to aircraft ground travel.

It is yet another object of the present invention to provide a method for reducing aircraft maintenance, repair, and overhaul costs related to aircraft ground travel.

In accordance with the aforesaid objects, a method for reducing both an aircraft's scheduled and unscheduled maintenance costs and an aircraft's time out of service for maintenance is provided. The present method is implemented by providing onboard drive wheel means on an aircraft that is capable of translating torque through aircraft wheels and controllable to move the aircraft independently on the ground without complete reliance on the aircraft's engines or the use of external tow vehicles. Aircraft are equipped with one or more drive wheels, each of which may be powered by onboard electric, hydraulic, or other wheel drive means that are controllable to move the aircraft efficiently during ground travel between landing and takeoff. Substantially eliminating the use of an aircraft's main engines and tow vehicles to move the aircraft on the ground between landing and takeoff significantly reduces required aircraft maintenance and, as a result, aircraft time out of service.

Other objects and advantages will be apparent from the following description, drawings, and claims.

### BRIEF DESCRIPTION OF THE SOLE DRAWING

FIG. 1 is a table showing some of the maintenance and cost savings that can be achieved relating to aircraft engines, aircraft brakes, and eliminating the need for tugs and tow vehicles with the method of the present invention.

### DESCRIPTION OF THE INVENTION

Airlines rely on their maintenance operations to decrease turnaround time, improve throughput, and reduce costs, all at the same time. To date, the only available approach for achieving this has been to improve maintenance operations, primarily through efforts to make maintenance scheduling and/or maintenance, repair, and overhaul operations more efficient. Until the present invention, there has been no reliable way to substantially eliminate factors that exacerbate or contribute to the need for unscheduled or scheduled aircraft maintenance that keeps aircraft out of service. Consequently, there has been no reliable or predictable way to reduce either or both of aircraft time out of service or maintenance costs.

Among the largest contributors to aircraft maintenance costs are aircraft systems and structures identified by the Federal Aviation Administration (FAA) and other certification and inspection authorities worldwide as required inspection items. Examples of required inspection items include airframe and engine structural components, flight controls and surfaces, and some avionics and navigational equipment. Landing gear and brakes are also responsible for significant aircraft maintenance costs. If these items are not properly maintained and inspected, their malfunction or failure could endanger the continued safe flight and landing of the aircraft. If at least some of the conditions that result in the need for maintenance for these items could be changed, maintenance tasks and, therefore costs and time out of service for maintenance, repair, and overhaul could be reduced. With the present method, the cost of maintenance and the time an aircraft is out of service for maintenance can be reduced significantly, even for older aircraft.

A main cause of reduced engine operating efficiency that must be addressed during scheduled and unscheduled maintenance is foreign object damage (FOD) resulting from foreign object debris that occurs while the aircraft is traveling on the ground in gate areas and taxiways with its engines running. Foreign object debris can include almost anything that is close enough to an operating aircraft engine to be sucked into the engine nacelle and the area close to the rotating turbines, an event referred to as engine ingestion. If the foreign object debris includes hard materials, such as, for example, aircraft rivets, aircraft bolts, maintenance tools, bits of runway paving, or soft drink cans, this material hits against the turbine blades and causes damage ranging from scratches to dents. What appears to be a small amount of damage can produce inefficiencies in blade operation. Inefficiencies in blade operation can be mitigated by blade blending. Blade blending attempts to mitigate blade damage by sanding down the blades to make them smoother. Over time, this type of damage, corrected or uncorrected, accumulates and could require an aircraft to be out of service for a significant period of time when it is discovered. In many cases, the turbine blades need to be replaced, which can be a lengthy process. With the method of the present invention, turbine blades are less likely to accumulate foreign object damage from foreign object debris, in large part because the engines are in operation for only a relatively short time while the aircraft is on the ground. According to accepted studies, 85% of FOD is caused on taxiways and in ramp areas by the ingestion of foreign object debris. Because runways are constantly checked, the damage from runway foreign object debris is generally minor, except in catastrophic circumstances during take off.

Increased maintenance may be required when aircraft are towed and/or pushed back prior to takeoff by tow vehicles, both towbarless tugs that lift an aircraft's nose wheel landing gear completely off the ground during towing and tugs that require the attachment of a tow bar. Not only does the way the landing gear is lifted off the ground by a towbarless tug so that its full weight is borne by the tug a likely contributor to damage, but the attachment operation can also jolt the airframe and the landing gear. This can subject an aircraft to stresses which it was not designed to sustain and may lead to long term maintenance challenges. An aircraft being towed by a tug with a tow bar is no less likely to experience landing gear damage; the damage results from forces applied in a different direction. Towing an aircraft on the ground can have adverse affects on aircraft landing gear structures during attachment of the tow vehicle as well as during pushback and towing. Increased scheduled and unscheduled maintenance, as well as the repair or replacement of damaged landing gear and additional aircraft time out of service may result from the movement of aircraft by any kind of tug or tow vehicle.

Aircraft brakes also require increased maintenance as the brakes are applied to counteract engine thrust and, essentially, to fight against the engine to keep the aircraft under control during movement over the taxiways and ramp areas. Aircraft engines are designed to operate optimally at altitude and at air travel speeds rather than at ground speeds that vary from a standstill to upwards of 30 miles per hour. The use of the brakes to slow the aircraft on landing and then to try to maintain a constant, smooth taxi speed, as is currently done, can shorten the effective life of the brakes and lead to frequent repairs or replacement of the brakes, while increasing shocks to the airframe. The application of brakes during aircraft ground travel when engines are running is typically not a smooth operation and can cause the entire aircraft to jerk as brakes are applied to moving wheels.

New aircraft can be designed and constructed in a way that reduces maintenance costs, and newer aircraft generally have much lower maintenance costs than older aircraft. This is demonstrated by a comparison of airframe maintenance costs for the older Boeing 737-400 and the newer Boeing 737-800, after three years of operation, which indicated that the airframe maintenance costs for the newer aircraft were about 10% less. Most airlines operate fleets made up of older aircraft, and reducing maintenance costs by acquiring new aircraft is not a viable or cost-effective option. The method of the present invention enables existing aircraft to achieve the significant savings possible when the need for aircraft maintenance is reduced and aircraft time in service is increased. As a result, an aircraft can remain economical to operate for many years past its normal retirement age.

In accordance with the present method for reducing aircraft maintenance costs and aircraft time out of service, an aircraft is equipped with one or more powered drive wheels, which can be powered nose drive wheels or powered main drive wheels. The one or more powered drive wheels, which are preferably nose wheels, are uniquely positioned to maneuver the aircraft in a variety of circumstances on the ground without complete reliance on the aircraft's engines or external tow vehicles or tugs. The terms “drive wheels” and “powered drive wheels,” as used herein, refer to any aircraft wheels that are connected to and powered or driven by an onboard driver or drive means to move an aircraft independently during ground travel as described below. An onboard driver or drive means for a powered drive wheel optimally exerts sufficient power to propel or move the aircraft at runway speeds, and its preferred small size enables the driver or drive means to fit within a nose wheel or main wheel landing gear space or in any other convenient onboard location inside or outside the wheel, without limitation. An aircraft with one or more powered drive wheels will have one or more wheel drivers mounted in driving relationship with one or more of the aircraft wheels to move the wheels at a desired speed and torque and, thus, move the aircraft on the ground without reliance on the aircraft's main engines or external tow vehicles.

The present method allows the aircraft's engines to be turned off very shortly after landing and to remain off until shortly before takeoff. Substantially eliminating reliance on the use of the aircraft engines during taxi also reduces aircraft fuel consumption and eliminates the jet blast, engine ingestion, noise, and air pollution associated with operation of an aircraft's engines on the ground. If an aircraft engine is required to provide back up electric power in an emergency situation, as discussed below, the engine can be set to provide no thrust. Tugs are also not required to move aircraft, and the potential for damage to aircraft structures from tug attachment and/or towing that leads to time out of service is eliminated. Consequently, a safer, quieter, and less congested runway and ramp environment is possible.

Ground movement of the aircraft is produced instead of using main engines or tow vehicles by the operation of one or more onboard drivers or drive means drivingly associated with one or more of the aircraft wheels. The driver or drive means is powered independently of the aircraft's engines to cause one or more of the aircraft's wheels to rotate at a desired speed, or at a torque associated with a desired speed, while the aircraft is on the ground, thus providing the power required to move the aircraft at the desired speed. However, in rare circumstances, generators on the aircraft engines may be used as emergency backup power to power electric drive means. Bleed air from an aircraft engine may be used to power pneumatic drive means.

While a preferred location for a driver or drive means is adjacent to or within an aircraft wheel, driver locations are not limited. A driver can be positioned at any location where it can be connected with one or more aircraft wheels to provide the driving power required to move the aircraft wheel or wheels at a desired speed or torque and, hence, the aircraft at a desired speed on the ground. Possible locations for one or more drivers in addition to those within or adjacent to a wheel include, without limitation, on or near the wheel axle, in, on or near a landing gear bay or landing gear component, or any convenient onboard location in, on, or attached to the aircraft.

The aircraft's auxiliary power unit (APU) is the preferred source of electric power for powering drivers that require electric power. In the event, however, that the APU is inoperative or otherwise unavailable for supplying electric power, one or more of the aircraft's main engines' auxiliary power units could be used as a back-up power source, although this is likely to be encountered rarely, if at all. While the aircraft engines' auxiliary power units do not supply power nearly as efficiently as the aircraft's APU, they do provide an available alternative. Should it be necessary to rely on one or more engines to supply power or bleed air, the thrust levels can be set so that the engine or engines are providing only electric or pneumatic power to power the drive wheel to move the aircraft and are not providing thrust. Using the aircraft's main engines to power a drive wheel under these circumstances may result in a partial loss of economic and other benefits and advantages of not using the aircraft engines during ground travel. Such engine use may be justified, in the event of an APU failure for example, to obtain at least some of the benefits of powered drive wheel-controlled aircraft ground movement.

The terms “driver” and “drive means,” as used herein, refer to any onboard driver or drive means, whether or not located in a wheel, that is capable of moving an aircraft on the ground. Drivers preferred for use with the method of reducing aircraft maintenance and time out of service of the present invention could be hydraulic, pneumatic, electric, or any other type of driver that can transfer force through an aircraft wheel and move an aircraft on the ground. One particularly preferred driver is an electric driver that is preferably an enclosed machine capable of operating for at least several minutes at maximum torque and for over 20 minutes at cruise torque. This electric driver could be any one of a number of designs, for example an inside-out motor attached to a wheel hub in which the rotor can be internal to or external to the stator, such as that shown and described in U.S. Patent Application Publication No. 2006/0273686, the disclosure of which is incorporated herein by reference. A toroidally-wound motor, an axial flux motor, a permanent magnet brushless motor, a synchronous motor, an asynchronous motor, a pancake motor, a switched reluctance motor, electric induction motor, or any other electric motor geometry or type known in the art is also contemplated to be suitable for use in the present invention.

The driver selected, whether hydraulic, pneumatic, electric, or any other type of driver, should be able to move an aircraft wheel at a desired speed and torque. One kind of electric drive motor preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. As indicated above, any form of driver, drive means, or motor capable of driving a landing gear wheel to move an aircraft on the ground may also be used. Other motor designs capable of high torque operation across the desired speed range that can move an aircraft wheel to function as described herein may also be suitable for use in the present invention. A particularly preferred drive means, suitable for use in, for example, the Boeing 737 family of aircraft and the Airbus A320 family of aircraft, is a high phase order induction motor with a top tangential speed of about 15,000 linear feet per minute and a maximum rotor speed of about 7200 rpm. With an effective wheel diameter of about 27 inches and an appropriate gear ratio, an optimum top speed of about 28 miles per hour (mph) can be achieved, although any speed appropriate for aircraft ground travel in a particular runway environment could be achieved. For other manufacturers' models of aircraft, the preferred motor specifications would be different.

A wheel driver or drive means capable of reducing aircraft maintenance costs and time out of service in accordance with the present invention is specifically designed to be fitted on new aircraft as they are being built or on older aircraft after they have been built. Additionally, this wheel driver can be retrofitted on existing aircraft without requiring changes to existing wheel structures, including the brakes, to produce powered drive wheels. A major advantage of the design of this wheel driver is achieved by the continued use of the existing tires, axle, and piston already in use on an aircraft. Since these structures are not altered from their original condition or otherwise changed in any way by the installation of the present wheel driver, the rim width, tire bead, and bead seat should not require re-certification by the FAA or the other various worldwide aviation authorities, thus eliminating a potentially time consuming and costly process, whether an aircraft is in production, just off the production line, or a retrofit aircraft. As a result, the wheel driver described herein is especially well suited for installation on existing older aircraft to reduce maintenance costs and the time these aircraft are out of service. The controls required to operate a wheel driver as described herein can be also retrofitted within the existing cockpit controls. Retrofitting an existing aircraft with one or more wheel drive means and the controls to operate these drive means can be accomplished within a relatively short period of time.

Moving an aircraft on the ground using a wheel driver as described above requires providing sufficient power to the driver to produce a torque capable of driving an aircraft wheel to move the aircraft at a desired ground speed. When an electric drive means is used in the present method, the current, and the voltage and frequency of the current applied to the motor can be controlled to regulate speed. In an aircraft wheel drive assembly useful in the present invention, as noted above, current to power the motor preferably originates with the aircraft auxiliary power unit (APU). Other power sources could also be used to supplement or replace the APU as a source of power. These power source can include, for example without limitation, batteries, fuel cells, any kind of solar power, POWER CHIPS™, and burn boxes, as well as any other suitable power source for this purpose. Control of the flow of current to the drive means, as well as the voltage and frequency of the current, allows the torque generated by the drive means to be controlled and, therefore, the speed of the wheel powered by the drive means and the ground travel speed of the aircraft can be controlled.

A motor control system suitable for controlling an onboard electric driver or drive means is described in commonly owned U.S. Patent Publication No. US2008/0147252 to Bayer, the disclosure of which is incorporated herein by reference. The control system described by Bayer includes software that uses a closed loop control in conjunction with other control laws to operate one or more electric motors of the type described above to move an aircraft during taxi.

As discussed above, in accordance with the present method, an aircraft's ground movement is not powered by the aircraft's main engines, but is powered only by the aircraft's auxiliary power unit (APU). Not only is engine damage likely to be substantially eliminated because engine operation while the aircraft is on the ground is minimal, but damage to the aircraft brakes and airframe previously requiring repair and/or maintenance that took an aircraft out of service is also unlikely. Other required inspection items, including landing gear components, which are no longer subjected to damage from tug connections and towing, additionally require less maintenance and, therefore, less time out of service.

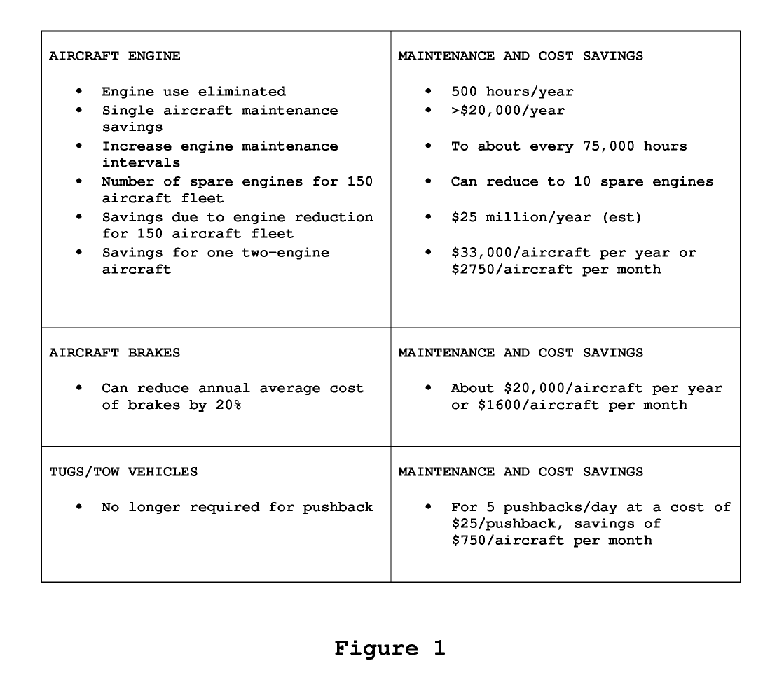

FIG. 1 shows, in table form, some of the maintenance and cost savings that can be achieved with the method of the present invention. These maintenance and cost savings, which are based on conservative estimates, are described below.

When an aircraft is equipped with one or more powered drive wheels, the aircraft engines are shut off during ground travel, and generally at least 500 hours of engine use can be eliminated annually. Foreign object damage to engine components is no longer a major concern, and the reduction in engine maintenance, repair, and overhaul requirements due to FOD with the present method is estimated to be very significant. Annual engine maintenance savings for a single aircraft have been estimated to be substantially in excess of $20,000 with the present invention, and these savings are anticipated to increase.

Additionally, costs of obtaining replacement or spare engines to minimize aircraft out of service time when a damaged engine requires maintenance, repair, or overhaul are substantially reduced by the present invention. The number of spare engines an airline typically keeps for use during engine maintenance of its fleet can also be reduced. Engines can stay on wing longer since they are not relied on for taxi, and maintenance intervals can be lengthened, to an estimated 7,500 hours between scheduled maintenance shop visits. It is estimated that for a fleet of 150 aircraft, the method of the present invention could reduce the number of spare engines needed to replace engines in maintenance, repair, or overhaul by 10. At a conservatively estimated spare engine cost of about $2.5 million, the airline's capital savings would be at least $25 million for a fleet of 150 aircraft. Eliminating the need for an airline to have this extra inventory of engines produces savings of about $33,000 per year for a two engine aircraft, based on a 10% cost of capital and an engine cost of about $16,666 per engine per year. Monthly savings would be at least $2750 per aircraft. Although the foregoing figures are computed on the basis of a 150 aircraft fleet and a reduction in spare engines of 10, they reflect per aircraft savings and do not depend on the size of an airline's fleet.

The method of the present invention will provide a very large reduction in braking activity with along with a substantial decrease in shocks to the airframe from braking compared to when the engines are operating during ground travel. It is not necessary to apply the aircraft's brakes to reduce the aircraft's speed since braking action can be accomplished with the onboard driver. As a result, ground travel is significantly smoother than in the past, and large reductions in brake usage and, thus, brake replacement and maintenance are also achieved. This reduction in braking activity and decrease in shocks to the airframe reduces damage to the aircraft brakes and airframe and, therefore, further reduces the repair and associated maintenance costs associated with these structures that are required to keep the aircraft in service. According to one estimate, the elimination of the need for braking during aircraft taxi could reduce the average annual cost of an aircraft's brakes, which is almost $100,000, by 20%. This represents a minimal annual savings per aircraft per year of about $20,000, or about $1600 per month for each aircraft.

Adverse stresses and forces on an aircraft's landing gear caused by positioning and securing the landing gear to a tow bar or on a towbarless tug lift cradle that damage landing gear are eliminated when the aircraft is driven on the ground by powered drive wheels. Since aircraft are self-propelled on the ground at all times by wheel drive means and do not require tugs, damage to landing gear resulting from the use of tugs to move aircraft is also eliminated. With the elimination of major causes of increased landing gear maintenance, costs resulting from repair to damaged landing gear and aircraft time out of service for these repairs can be decreased significantly. In addition, landing gear maintenance demands will be significantly reduced, as will aircraft time out of service from tug-related landing gear damage and repairs. The costs associated with the use of tugs to move aircraft on the ground is also eliminated with the present invention. At a very conservative average cost estimate per pushback of $25, this can represent a substantial savings for an airline. If it is assumed that an airline requires 5 pushbacks per day, this is a total savings of at least $750 per month per aircraft. As pushback costs increase, the savings to airlines from not needing externally-assisted pushback by tugs also increase. It is anticipated that when these savings are verified by actual aircraft repair logs over time, they are expected to be quite significant and likely to exceed $30 per pushback.

With the reduction in foreign object debris-caused engine damage, airframe damage, and landing gear damage and the increase in brake life possible with the present invention, aircraft will be in service for longer periods of time than they are currently. By one estimate, aircraft should be available for service about 20% more days than at present. If an aircraft fleet, on average, is out of service for an average of 20 days a year for maintenance-related items and the out of service time is reduced by 20%, this effectively adds another 4% to the capacity of the carrier. An airline with a 150 aircraft fleet can generate the same revenue with a fleet of only 144 aircraft. The reduction of a fleet, while producing the same, or greater, revenue, can substantially improve an airline's profits. The potential savings to airlines possible with the method of the present invention is greater than the average profit historically generated by almost all airlines over any significant time span.

While the present invention has been described with respect to preferred embodiments, this is not intended to be limiting, and other arrangements and structures that perform the required functions are contemplated to be within the scope of the present invention.

### INDUSTRIAL APPLICABILITY

The method of the present invention will find its primary applicability in reducing airline costs associated with aircraft maintenance and in reducing the time aircraft are required to be out of service for maintenance, repair, and overhaul, effectively enabling an airline to increase its utilization of aircraft and to generate the same or greater revenue with a smaller fleet of aircraft.

1. A method comprising reducing airline costs for aircraft maintenance, repair, and overhaul and for reducing aircraft time out of service caused by requirements for maintenance, repair, and overhaul, wherein one or more of an airline's aircraft are equipped with onboard wheel drive means capable of translating torque through aircraft wheels and controllable to move the aircraft independently on the ground without reliance on the aircraft's engines or tow vehicles.

2. The method of claim 1, wherein said one or more aircraft are moved on the ground by onboard wheel drive means comprising any motor capable of producing the torque required to move a commercial sized aircraft at an optimum speed for ground movement.

3. The method of claim 2, wherein the onboard wheel drive means is selected from the group comprising electric induction motors, permanent magnet brushless DC motors, switched reluctance motors, hydraulic pump/motor assemblies, and pneumatic motors.

4. The method of claim 1, wherein the onboard wheel drive means is mounted on at least one aircraft nose wheel or on at least one aircraft main wheel.

5. The method of claim 3, wherein said onboard wheel drive means is powered by a power source selected from the group consisting of an aircraft's auxiliary power unit, an aircraft's main engines, batteries, fuel cells, solar power, POWER CHIPS™, and burn boxes.

6. The method described in claim 3, wherein said onboard wheel drive means is an electric motor capable of driving an aircraft on the ground selected from the group comprising high phase order electric motors, electric induction motors, permanent magnet brushless DC motors, and switched reluctance motors.

7. The method described in claim 1, wherein said onboard wheel drive means is located at a selected location inside an aircraft nose or main wheel, at a selected location adjacent to an aircraft nose or main wheel, at a selected location within the aircraft, or at a selected location attached to the aircraft airframe.

8. A method comprising quantifiably reducing aircraft annual maintenance requirements and costs, wherein an aircraft is equipped with an onboard drive means mounted to drive at least one of the aircraft's nose wheels without reliance on operation of the aircraft's main engines or tow vehicles, said drive means being controllable to move the aircraft independently on the ground by transmitting force through the wheels, thereby substantially eliminating likelihood of damage to aircraft structures requiring maintenance.

9. A method comprising reducing the time an aircraft is required to be out of service for scheduled or unscheduled maintenance by equipping said aircraft with an onboard drive means mounted to drive at least one of the aircraft's wheels and controllable to move the at least one of the aircraft's wheels to move the aircraft independently on the ground by transmitting force through the wheels, thereby reducing damage to said aircraft's landing gear, brakes, engines, and airframe.

10. The method of claim 9, wherein operating said onboard drive means to move said aircraft during pushback eliminates the need for a tow vehicle, thereby eliminating damage to said aircraft caused by a tow vehicle and reducing said time an aircraft is required to be out of service.

11. A method comprising reducing airline costs for aircraft maintenance, repair, and overhaul and for reducing aircraft time out of service caused by requirements for maintenance, repair, and overhaul, wherein a plurality of an airline's aircraft are equipped with onboard wheel drive means drivingly mounted on each of said plurality of aircraft's nose landing gear wheels, wherein said drive means comprise electric drive motors controllable to move the aircraft independently on the ground without operation of the aircraft's engines or use of tow vehicles, thereby eliminating damage to said aircraft engines, airframe, landing gear, and brakes caused by operation of said engines or use of said tow vehicles.

12. A method comprising reducing airline fleet maintenance costs by reducing the interval between aircraft engine maintenance events and a number of spare engines required to be stocked by an airline, wherein a plurality of said airline's aircraft are equipped with onboard drive means mounted to drive at least one of the aircraft's wheels on the ground without reliance on the aircraft's main engines or external tow vehicles, said drive means being controllable to move the at least one of said aircraft's wheels to move the aircraft independently on the ground by transmitting force through said wheels.
